(19) United States
(12) Patent Application Publication
(10) Pub. No.: US 2023/0073673 A1
(43) Pub. Date: Mar. 9, 2023

(54) MULTI-CAR ELEVATOR CONTROL DEVICE

(71) Applicant: Mitsubishi Electric Corporation, Tokyo (JP)

(72) Inventors: Satoru YAMAGUCHI, Tokyo (JP); Masayuki SUGAHARA, Tokyo (JP)

(73) Assignee: Mitsubishi Electric Corporation, Tokyo (JP)

(21) Appl. No.: 17/795,544

(22) PCT Filed: Mar. 31, 2020
(86) PCT No.: PCT/JP2020/014935

§ 371 Date: Jul. 27, 2022

(51) Int. Cl. B66B 13/14

(52) U.S. Cl. CPC B66B 13/146; B66B 2201/308

(57) ABSTRACT

A multi-car elevator control device that can shorten an open and close time of a door is provided. The multi-car elevator control device includes, in an elevator system including a plurality of cars that overlap each other on a horizontal projection plane, an open and close instruction judging part that changes, based on a motor speed or current in a moving time of a car door of a specified car, a control parameter of a car door of another car. According to the configuration, the multi-car elevator control device changes, based on the motor speed or current in the moving time of the car door of the specified car, the control parameter of the car door of the other car, in the elevator system including a plurality of cars that overlap each other on the horizontal projection plane. Therefore, the open and close time of the door can be shortened.

### FIELD

The present disclosure relates to a multi-car elevator control device.

### BACKGROUND

PTL 1 discloses a multi-elevator system. According to the multi-elevator system, operation efficiency of the elevator may be enhanced.

### CITATION LIST

### Patent Literature

[PTL 1] JP 2016-124682 A

### SUMMARY

### Technical Problem

However, in the multi-elevator system according to PTL 1, only an open and close instruction of a door is shared by a plurality of cars. Therefore, it is not possible to shorten the open and close time of the door.

### Solution to Problem

The present disclosure is made to solve the aforementioned problem. An object of the present disclosure is to provide a multi-car elevator control device that may shorten an open and close time of a door.

A multi-car elevator control device according to the present disclosure includes, in an elevator system including a plurality of cars that overlap each other on a horizontal projection plane, an open and close instruction judging part that changes, based on a motor speed or current in a moving time of a car door of a specified car, a control parameter of a car door of another car.

### Advantageous Effects

According to the present disclosure, the multi-car elevator control device changes, based on the motor speed or current in the moving time of the car door of the specified car, the control parameter of the car door of the other car, in the elevator system including a plurality of cars that overlap each other on the horizontal projection plane. Therefore, the open and close time of the door can be shortened.

### BRIEF DESCRIPTION OF DRAWINGS

FIG. 1 is a block diagram of a multi-car elevator system according to a first embodiment;

FIG. 2 is a front view of a first car door and a hatch door of the multi-car elevator system according to the first embodiment;

FIG. 3 is a plan view for explaining a relationship of the first car door or the like and the hatch door in the multi-car elevator system according to the first embodiment;

FIG. 4 is a block diagram for explaining a learning function of a first car door control device of the multi-car elevator system according to the first embodiment;

FIG. 5 is a diagram illustrating a learning effect of open and close of the door by the first car door control device of the multi-car elevator system according to the first embodiment;

FIG. 6 is a flowchart for explaining operation of the multi-car elevator control device of the multi-car elevator system according to the first embodiment;

FIG. 7 is a hardware block diagram of the multi-car elevator control device of the multi-car elevator system according to the first embodiment;

FIG. 8 is a block diagram for explaining a learning function of a first car door control device of a multi-car elevator system according to a second embodiment;

FIG. 9 is a diagram illustrating a learning effect of open and close of a door by the first car door control device of the multi-car elevator system according to the second embodiment;

FIG. 10 is a flowchart for explaining the operation of the multi-car elevator control device of the multi-car elevator system according to the second embodiment;

FIG. 11 is a block diagram for explaining a diagnosis function of a first car door control device of a multi-car elevator according to a third embodiment.

### DESCRIPTION OF EMBODIMENTS

Embodiments will be described in accordance with the accompanying drawings. Note that same or corresponding parts are assigned with same reference signs in each of the drawings. Redundant explanation of the parts is properly simplified or omitted.

### First Embodiment

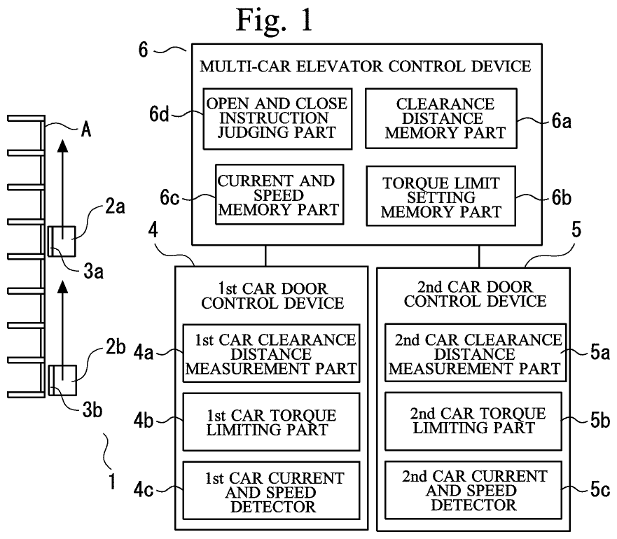

FIG. 1 is a block diagram of a multi-car elevator system in the first embodiment.

In FIG. 1, a hoistway 1 of an elevator is provided in a building not illustrated. The hoistway 1 is formed to penetrate through each floor of the building. Each of a plurality of halls not illustrated is provided on each floor of the building. Each of the plurality of halls faces the hoistway 1. Entrances of the plurality of halls not illustrated are formed in the respective plurality of halls. Each of a plurality of hatch doors A is provided in each of the plurality of hall entrances.

A first car 2a and a second car 2b are provided inside of the hoistway 1. The first car 2a and the second car 2b are positioned so as to overlap each other on a horizontal projection plane in the one hoistway 1. A first car entrance not illustrated is formed in the first car 2a. A second car entrance not illustrated is formed in the second car 2b. A first car door 3a is provided in the first car entrance. A second car door 3b is provided in the second car entrance.

A first car door control device 4 is connected to the first car 2a. The first car door control device 4 includes a first car clearance distance measurement part 4a, a first car torque limiting part 4b and a first car current and speed detector 4c.

A second car door control device 5 is connected to the second car 2b. The second car door control device 5 includes a second car clearance distance measurement part 5a, a second car torque limiting part 5b and a second car current and speed detector 5c.

A multi-car elevator control device 6 is connected to the first car door control device 4 and the second car door control device 5. The multi-car elevator control device 6 includes a clearance distance memory part 6a, a torque limit setting memory part 6b, a current and speed memory part 6c, and an open and close instruction judging part 6d.

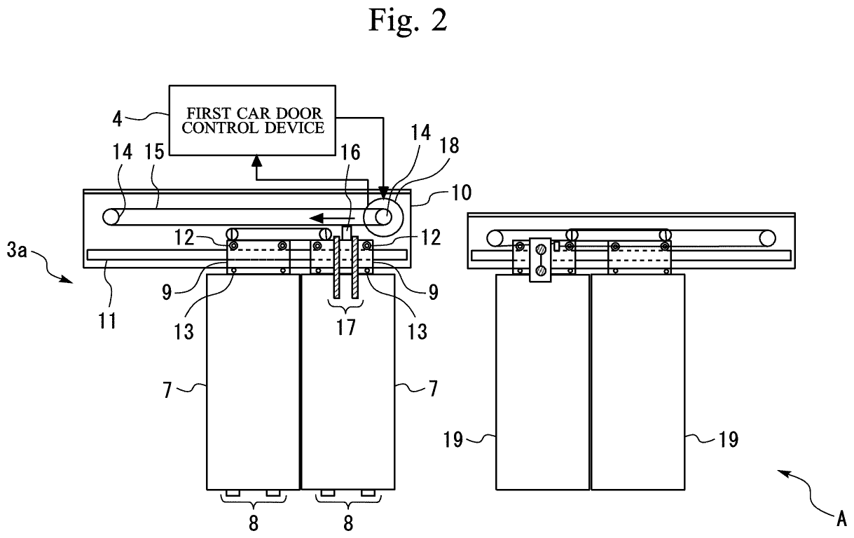

Next, the first car door 3a, the second car door 3b, and the hatch door A will be described with reference to FIG. 2.

FIG. 2 is a front view of the first car door and the hatch door of the multi-car elevator system in the first embodiment.

As illustrated in FIG. 2, the first car door 3a is a side operation type door. In the first car door 3a, a pair of car door panels 7 open and close the car entrance.

A first pair of shoes 8 are provided at a lower end of one of the pair of car door panels 7. The first pair of shoes 8 guide horizontal movement in one of the pair of car door panels 7 by moving inside of a groove of a sill not illustrated. A second pair of shoes 8 are provided at a lower end of the other one of the pair of car door panels 7. The second pair of shoes 8 guide horizontal movement in the other one of the pair of car door panels 7 by moving inside of the groove of the sill not illustrated.

A pair of hangers 9 are respectively provided at upper ends of the pair of car door panels 7. A girder 10 is provided at an upper edge portion of the car entrance so that a longitudinal direction is in a horizontal direction. A guide rail 11 is provided at the girder 10 so that a longitudinal direction is in the horizontal direction.

A first pair of hanger rollers 12 are provided at one of the pair of hangers 9. The first pair of hanger rollers 12 guide horizontal movement of one of the pair of hangers 9 by moving along the guide rail 11. A second pair of hanger rollers 12 are provided at the other one of the pair of hangers 9. The second pair of hanger rollers 12 guides horizontal movement of the other one of the pair of hangers 9 by moving along the guide rail 11.

A first pair of upthrust rollers 13 are provided at one of the pair of hangers 9. The first pair of upthrust rollers 13 are positioned under the guide rail 11. The first pair of upthrust rollers 13 prevent the first pair of hanger rollers 12 from slipping off from the guide rail 11. A second pair of upthrust rollers 13 are provided at the other one of the pair of hangers 9. The second pair of upthrust rollers 13 are positioned under the guide rail 11. The second pair of upthrust rollers 13 prevent the second pair of hanger rollers 12 from slipping off from the guide rail 11.

A pair of pulleys 14 are provided apart in the girder 10. A belt 15 is formed endlessly. The belt 15 is installed on the pair of pulleys 14. A groove not illustrated is formed on an outer peripheral surface of each of the pair of pulleys 14.

The belt 15 is a transmission belt. The belt 15 is set according to a shape of the groove of each of the pair of pulleys 14. For example, the belt 15 is a toothed belt or V belt. A tension of the belt 15 is adjusted by changing a distance between the pair of pulleys 14.

An upper end of a belt holder 16 is connected to the belt 15. A pair of car vanes 17 are connected to a lower end of the belt holder 16. A motor 18 drives one of the pair of pulleys 14.

When the motor 18 is energized by the first car door control device 4, one of the pair of pulleys 14 rotates. The belt 15 moves by following rotation of the one of the pair of pulleys 14. The car vane 17 moves following the belt holder 16 via the belt holder 16. One of the pair of car door panels 7 is connected to the car vane 17. The other one of the pair of car door panels 7 receives a drive force via the belt 15. As a result, the pair of door panels move in the same direction.

The first car door 3a is equipped with a mechanical door closing force generation mechanism and a mechanical door opening force generation mechanism not illustrated. The door closing force generation mechanism prevents an infant from prying open the first car door 3a and falling into the hoistway 1, even when a confinement occurs inside the first car 2a and an electric drive force of the motor 18 is lost. The door opening force generation mechanism makes it possible to keep full opening of the first car door 3a even when there is no drive force of the motor 18 or when the drive force of the motor 18 is small at a time of full opening of the first car door 3a.

Though not illustrated, a configuration of the second car door 3b is similar to the configuration of the first car door 3a.

A configuration of the hatch door A is also similar to the configuration of the first car door 3a except for a drive system. A pair of hatch door panels 19 are provided in a hall entrance. A hall roller 20 is provided at one of the pair of hatch door panels 19. When heights of the first car door 3a or the second car door 3b and the hatch door A substantially coincide with each other, if the motor 18 is energized, the hall roller 20 contacts the car vanes 17, and thereby the drive force of the first car door 3a or the second car door 3b is transmitted to the hatch door A. As a result, the pair of the hatch door panels 19 open.

In the hatch door A, a door closing force generation mechanism not illustrated is attached. The door closing force generation mechanism is formed of a weight, a spring and the like. The door closing force generation mechanism generates a mechanical external force so that even when the hatch door A is opened in a condition where the first car 2a or the second car 2b does not land, the hatch door A is fully closed automatically.

In a double sliding door, the car entrance can be opened and closed by setting the pair of car door panels 7 to move in opposite directions to each other via the belt 15.

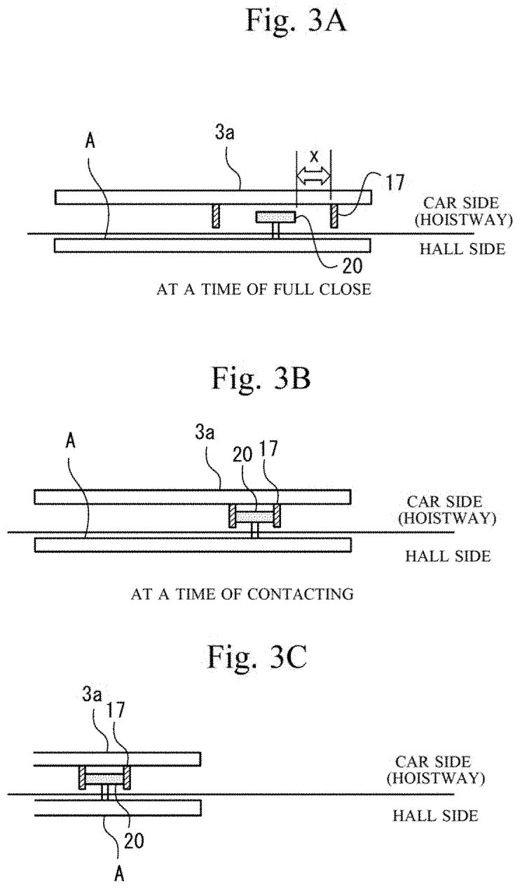

Next, a relationship of the first car door 3a or the like and the hatch door A will be described with reference to FIG. 3.

FIG. 3 is a plan view for explaining a relationship of the first car door or the like and the hatch door in the multi-car elevator system in the first embodiment.

As illustrated in FIG. 3, the car vanes 17 move inside of the hoistway 1. The hall roller 20 protrudes to the hoistway 1. The hall roller 20 is damaged when contacting equipment of the first car 2a or the second car 2b when the first car 2a or the second car 2b ascends and descends. In particular, when the hall roller 20 and the pair of car vanes 17 contact each other, both of them are damaged.

Therefore, adjustment of a mechanical system is required so that a clearance distance X between the car vanes 17 and the hall roller 20 is kept constant in a door full close condition at a time of ascent and descent of the first car 2a or the second car 2b. When the clearance distance is too short, a possibility of the equipment being damaged is high when a setting error at an installation time, a shape change due to secular change, or deformation of any of the first car door 3a, the second car door 3b and the hatch door A occurs.

As illustrated in FIG. 3(A), at a time of full close of the first car door 3a or the like, the car vanes 17 are apart from the hall roller 20 by the clearance distance X. When the motor 18 starts an opening motion of the first car door 3a or the like by a door open instruction, the car vanes 17 are driven in a door open direction. As illustrated in FIG. 3(B), the car vanes 17 contact the hall roller 20 at a time point when the car vanes 17 move in the door open direction by a distance corresponding to the clearance distance X. Thereafter, as illustrated in FIG. 3(C), during door open, the pair of car vanes 17 connect the car door and the hatch door A in a condition in which the car vanes 17 grip the car door. At the same time, the pair of car vanes 17 drive with the hall roller 20 completely sandwiched therebetween.

The clearance distance X in FIG. 3 is a distance between the car vanes 17 on a full close side and the hall roller 20. The distance between the car vanes 17 on a full open side and the hall roller 20 is calculated from the clearance distance X and a dimension of the hall roller 20, if the distance between the pair of coupling vanes is known.

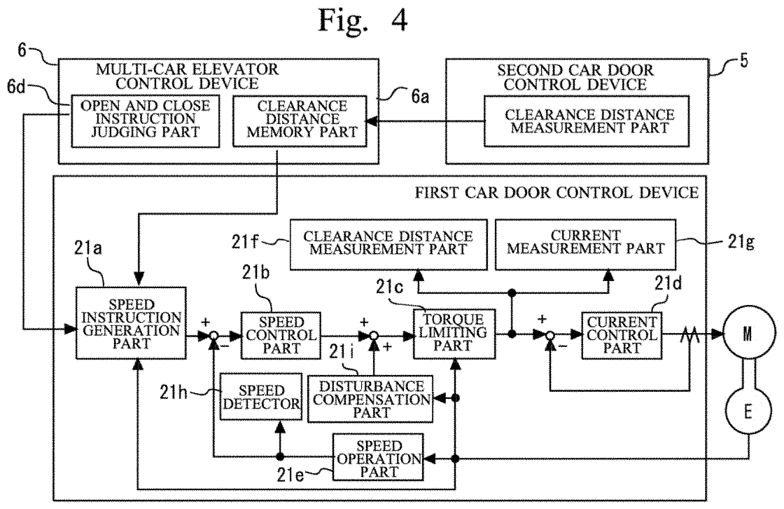

Next, a learning function of the first car door control device will be described by using FIG. 4.

FIG. 4 is a block diagram for explaining the learning function of the first car door control device of the multi-car elevator system in the first embodiment.

In the first car door control device 4 in FIG. 4, a speed instruction generation part 21a outputs a speed instruction to be a target in an open and close operation. In an actual driving device, disturbances such as running resistance such as dust clogging, friction loss due to deformation of a door panel, and contact with a matter during drive of the door panel occur. Therefore, it is necessary to correct a speed error with an actual speed by a speed control part 21b. Drive of the motor 18 is controlled so that an actual speed V follows a target speed instruction value V* at regular time intervals.

For example, the speed control part 21b is a feedback controller shown by transmission function: C_{b}(s)=Kₛₚ+Kₛᵢ/S. Here, Kₛₚ is a proportional gain. Kₛᵢ is an integration gain.

A torque limiting part 21c receives torque that is an output of the speed control part 21b as an input. The torque limiting part 21c outputs a current instruction value of the motor 18. When contact occurs between the door panel which is opening or closing and a human body, a difference occurs between the actual speed V and the speed instruction value V*, and the torque limiting part 21c limits the torque so that excessive energy is not given to the human body as a result.

A current control part 21d feeds back a detected current value by a current detector to control a current value that is supplied to the motor 18 so as to supply a current to the motor 18 based on the current instruction value of the motor 18. An output of the current control part 21d is input to the motor 18 via a PWM inverter. As a result, a drive force for opening and closing the door is generated.

For example, a sensor E is an encoder, or resolver. The sensor E detects rotation of the motor 18. The sensor E outputs a rotational position of the motor 18.

A speed operation part 21e performs arithmetic operation of the rotational speed by sampling the input rotational positions at regular time intervals, and thereafter outputs the rotational speed.

The rotational position or the rotational speed of the motor 18 may be estimated by using a detected current value instead of the sensor E.

A clearance distance measurement part 21f detects contact of the coupling vanes of the car door and the hall roller 20 of the hatch door A by using the current instruction value of the motor 18 that is an output of the torque limiting part 21c or the actual speed that is the rotational speed of the motor 18 which is the output of the speed operation part 21e. The clearance distance measurement part 21f outputs the rotational position of the motor 18 at a detection time. On this occasion, the measured clearance distance is communicated to the multi-car elevator control device 6.

A current measurement part 21g stores a current instruction value of the motor 18 that is the output of the torque limiting part 21c. A speed detector 21h stores an actual speed that is the output of the speed operation part 21e.

A disturbance compensation part 21i compensates a mechanical external force by a door close force generation mechanism of the hatch door A, and a known external force by a door opening and closing force generation mechanism of the car door, in advance. When an external force is generated in the car door or the hatch door A due to deformation of the panel, or the like except for the mechanical external force, the disturbance compensation part 21i improves followability of the actual speed V to the speed instruction value V* by compensating the learned external force in advance.

A configuration of the second car door control device 5 is also similar to the configuration of the first car door control device 4.

In the multi-car elevator control device 6, the clearance distance memory part 6a memorizes the measurement results of the clearance distance measurement parts 21f of the first car door control device 4 and the second car door control device 5.

When no tilt due to imbalance load by users, or abnormality in the mechanical system occurs to the first car 2a and the second car 2b, a variation in the clearance distance immediately after installation is due to misalignment of the hall roller 20.

The open and close instruction judging part 6d judges that a variation amount of the clearance distance that is measured when the first car 2a lands on the same floor at a previous time with respect to the clearance distance that is measured when the first car 2a opens and closes the door at this time corresponds to the misalignment of the hall roller 20. The open and close instruction judging part 6d adds the variation amount to the clearance distance which is measured when the second car 2b lands on the same floor and opens and closes the door at the previous time, and updates the clearance distance for the second car 2b to open and close next. The open and close instruction judging part 6d transmits the updated clearance distance to a speed instruction generation part 21a of the second car door control device 5.

When car tilt due to imbalance load by the users or abnormality in the mechanical system occurs to the first car 2a and the second car 2b, an effect by the tilt can be eliminated if the car tilt can be measured by an acceleration sensor or the like. When the tilt cannot be directly measured by the sensor, a difference in clearance distance due to tilt of the first car 2a and the second car 2b on the same floor can be memorized in a maintenance mode in which no user exists. In this case, the open and close instruction judging part 6d judges the clearance distance of the second car 2b on the same floor by adding or subtracting the aforementioned difference to or from the clearance distance measured in the first car 2a.

Concerning the effect of the imbalance load by the users, car tilt assumed from the rated number of passengers may be estimated. Existence or absence of the user can be detected by a device that measures a load variation of the car by the user, for example, a load weighing device of the car.

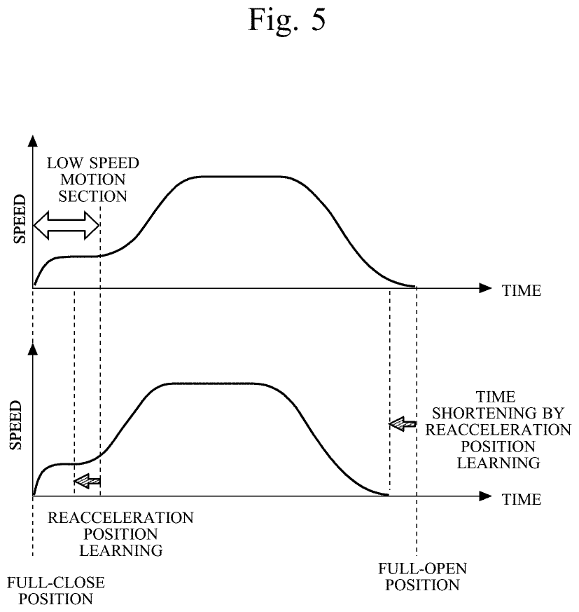

Next, learning of open and close of the door will be descried by using FIG. 5.

FIG. 5 is a diagram illustrating a learning effect of open and close of the door by the first car door control device of the multi-car elevator system in the first embodiment.

When the elevator opens the door from full close, only the first car door 3a or the like moves. Thereafter, the coupling vanes of the first car door 3a or the like and the hall roller 20 contact each other, and thereby the first car door 3a or the like and the hatch door A connect to each other. When the first car door 3a or the like opens the door at a high speed before the connection, impact sound due to contact of the car vanes 17 and the hall roller 20 increases. Due to the effect of the impact, the panels of the first car door 3a or the like that are hung on the guide rail 11 or the panels of the hatch door A swing, and thereby appearance may be deteriorated.

Accordingly, the first car door 3a or the like moves at a low speed until the car vanes 17 and the hall roller 20 contact each other. Thereafter, the first car door 3a or the like reaccelerates after connected to the hatch door A. On this occasion, if the position of the hatch door A to be coupled is unknown, the impact sound can be reduced, and swing of the door panels due to the impact can also be reduced by setting the position of the first car door 3a or the like that is reaccelerated at a maximum value that is assumed with the clearance distance. However, a door open time increases.

In contrast to this, from a variation of the clearance distance that is measured in one of the first car 2a and the second car 2b, the multi-car elevator control device 6 estimates a clearance distance of the other one of the first car 2a and the second car 2b that lands next. Accordingly, when the user or a trolley contacts the hatch door panel 19, and thereby the position of the hall roller 20 displaces, a low speed motion section of the first car door 3a or the like always becomes the shortest. Further, the open and close time of the first car door 3a or the like is shortened.

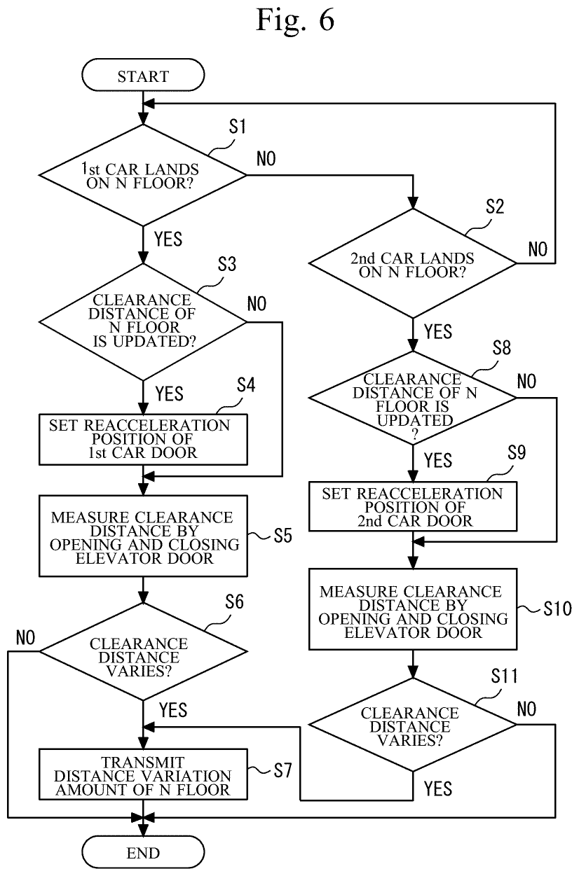

Next, operation of the multi-car elevator control device 6 will be described with use of FIG. 6.

FIG. 6 is a flowchart for explaining the operation of the multi-car elevator control device of the multi-car elevator system in the first embodiment.

In step S1, the multi-car elevator control device 6 judges whether or not the first car 2a lands on an N floor.

When the first car 2a does not land on the N floor in step S1, the multi-car elevator control device 6 performs an operation in step S2.

In step S2, the multi-car elevator control device 6 judges whether or not the second car 2b lands on the N floor.

When the second car 2b does not land on the N floor in step S2, the multi-car elevator control device 6 performs the operation in step S1.

When the first car 2a lands on the N floor in step S1, the multi-car elevator control device 6 performs an operation in step S3.

In step S3, the multi-car elevator control device 6 judges whether or not a clearance distance of the N floor is updated.

When the clearance distance of the N floor is updated in step S3, the multi-car elevator control device 6 performs an operation in step S4. In step S4, the multi-car elevator control device 6 sets a reacceleration position of the first car door 3a.

When the clearance distance of the N floor is not updated in step S3, or after step S4, the multi-car elevator control device 6 performs an operation in step S5. In step S5, the multi-car elevator control device 6 measures the clearance distance by opening and closing the door of the elevator.

Thereafter, the multi-car elevator control device 6 performs an operation in step S6. In step S6, the multi-car elevator control device 6 judges whether or not the clearance distance varies.

When the clearance distance varies in step S6, the multi-car elevator control device 6 performs an operation in step S7. In step S7, the multi-car elevator control device 6 transmits a distance variation amount of the N floor.

When the clearance distance does not vary in step S6 or after step S7, the multi-car elevator control device 6 ends the operation.

When the second car 2b lands on the N floor in step S2, the multi-car elevator control device 6 performs an operation in step S8.

In step S8, the multi-car elevator control device 6 judges whether or not the clearance distance of the N floor is updated.

When the clearance distance of the N floor is updated in step S8, the multi-car elevator control device 6 performs an operation in step S9. In step S9, the multi-car elevator control device 6 sets a reacceleration position of the second car door 3b.

When the clearance distance of the N floor is not updated in step S8 or after step S9, the multi-car elevator control device 6 performs an operation in step S10. In step S10, the multi-car elevator control device 6 measures the clearance distance by opening and closing the door of the elevator.

Thereafter, the multi-car elevator control device 6 performs an operation in step S11. In step S11, the multi-car elevator control device 6 judges whether or not the clearance distance varies.

When the clearance distance varies in step S11, the multi-car elevator control device 6 performs the operation in step S7.

When the clearance distance does not vary in step S11, the multi-car elevator control device 6 ends the operation.

According to the first embodiment described above, based on the speed or the current of the motor in the moving time of the car door of the specified car, the multi-car elevator control device 6 changes the control parameter of the car door of the other car. Accordingly, the open and close time of the door can be shortened.

For example, the multi-car elevator control device 6 uses the clearance distance of the car door and the hatch door in each floor as the control parameter, and based on the clearance distance estimated in one car door, changes the door open reacceleration position of the other car door that lands on the same floor. Accordingly, the open and close time of the door can be more reliably shortened.

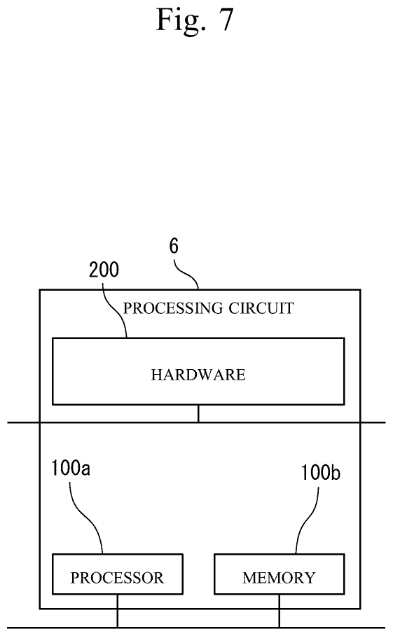

Next, an example of the multi-car elevator control device 6 will be described with use of FIG. 7.

FIG. 7 is a hardware block diagram of the multi-car elevator control device of the multi-car elevator system in the first embodiment.

The respective functions of the multi-car elevator control device 6 can be realized by a processing circuit. For example, the processing circuit includes at least one processor 100a and at least one memory 100b. For example, the processing circuit includes at least one dedicated hardware 200.

When the processing circuit includes at least one processor 100a and at least one memory 100b, the respective functions of the multi-car elevator control device 6 are realized by software, firmware, or a combination of software and firmware. At least one of the software and the firmware is described as a program. At least one of the software and the firmware is stored in at least the one memory 100b. At least the one processor 100a realizes the respective functions of the multi-car elevator control device 6 by reading and executing the program memorized in at least the one memory 100b. At least the one processor 100a is also referred to as a central processing unit, a processing unit, an arithmetic operation unit, a microprocessor, a microcomputer, or DSP. For example, at least the one memory 100b is a nonvolatile or volatile semiconductor memory such as RAM, ROM, flash memory, EPROM, or EEPROM, a magnetic disk, a flexible disk, an optical disk, a compact disk, a minidisk, DVD or the like.

When the processing circuit includes at least one dedicated hardware 200, the processing circuit is realized by, for example, a single circuit, a composite circuit, a programmed processor, a parallel programmed processor, ASIC, FPGA, or a combination of these. For example, respective functions of the multi-car elevator control device 6 are each realized by the processing circuit. For example, the respective functions of the multi-car elevator control device 6 are collectively realized by the processing circuit.

Some of the respective functions of the multi-car elevator control device 6 may be realized by the dedicated hardware 200, and the other parts may be realized by software or firmware. For example, the function of the open and close instruction judging part 6d may be realized by the processing circuit as the dedicated hardware 200, and the other functions than the function of the open and close instruction judging part 6d may be realized by at least the one processor 100a reading and executing the program stored in at least the one memory 100b.

In this way, the processing circuit realizes the respective functions of the multi-car elevator control device 6 by the hardware 200, software, firmware, or the combination of these.

Though not illustrated, the respective functions of the first car door control device 4 are also realized by an equivalent processing circuit to the processing circuit that realizes the respective functions of the multi-car elevator control device 6. The respective functions of the second car door 3b control device are also realized by an equivalent processing circuit to the processing circuit that realizes the respective functions of the multi-car elevator control device 6.

### Second Embodiment

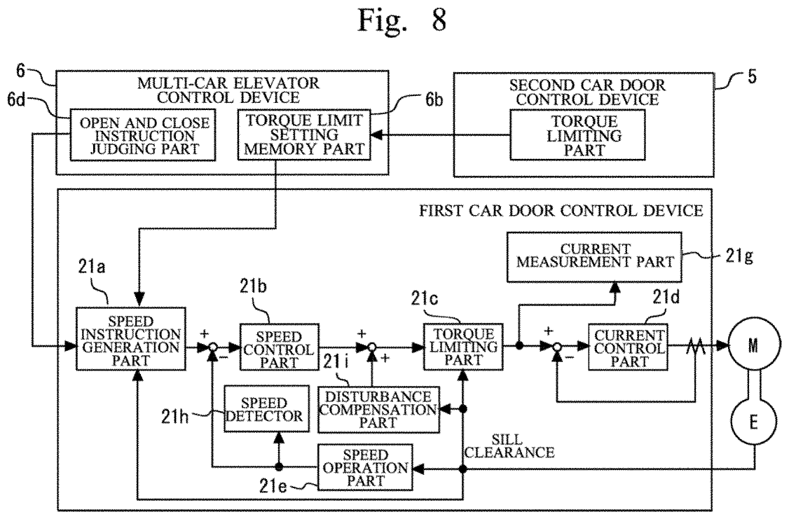

FIG. 8 is a block diagram for explaining a learning function of a first car door control device of a multi-car elevator system in a second embodiment. The same or corresponding parts as or to the parts of the first embodiment are assigned with the same reference signs. Explanation of the parts is omitted.

In FIG. 8, if an actual speed according to a speed instruction value is maintained when panels of a first car door 3a or the like or a hatch door A deform by colliding with a user or a trolley, for example, the first car door 3a or the like can be opened and closed by increasing torque. For example, when an alien object enters between a hanger roller 12 and a guide rail 11, if the actual speed according to the speed instruction value is maintained, the first car door 3a or the like can be opened and closed by increasing the torque. For example, when an alien object enters between shoes 8 and a groove in a sill, if the actual speed according to the speed instruction value is maintained, the first car door 3a or the like can be opened and closed by increasing the torque.

When the increased torque reaches a limit value set in advance, if the first car door 3a or the like does not move with setting of the prearranged limit value, the first car door 3a or the like retries a door open or door close motion by performing a door reversal motion.

When the first car door 3a or the like repeats the door reversal motion, the torque limit value should not be changed, if it is due to contact with a human body. On the other hand, if it is due to panel deformation or alien object entry, continuous service should be provided to the user by opening and closing the first car door 3a or the like by raising the torque limit value.

Contact with a human body can be detected by operation of an optical sensor, a sound wave sensor, and a mechanical switch attached to the door. On the other hand, panel deformation, and alien object entry cannot detected by the optical sensor and the like. Whether or not a cause is contact with a human body can be separated.

When the cause is not contact with a human body, a torque limiting part 21c judges that loss due to panel deformation or alien object entry increases.

A second car door 3b control device transmits a torque limit value of a second car 2b with which it lands on a specified floor and can open and close the door to full open or full close to a multi-car elevator control device 6. When the torque limit value is changed from setting at a time of the second car 2b opening and closing on the same floor at a previous time, the multi-car elevator control device 6 transmits the torque limit value to a first car door control device 4. The first car door control device 4 reflects a change amount of the torque limit value in a torque limit value of the first car 2a that lands on the same floor next and opens and closes the first car door 3a.

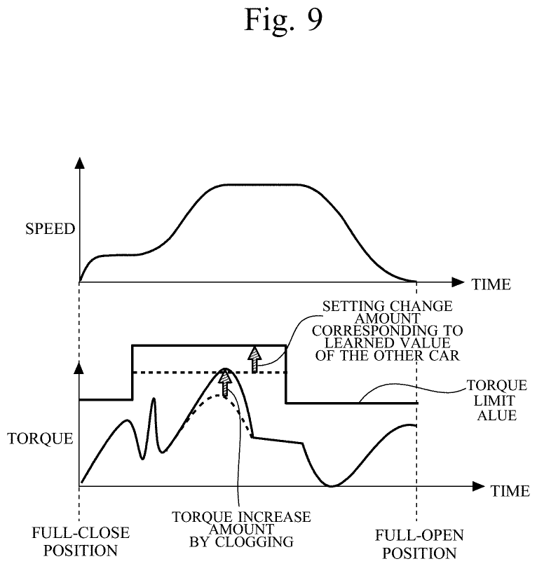

Next, change of the torque limit value will be described with use of FIG. 9.

FIG. 9 is a diagram illustrating a learning effect of open and close of the door by the first car door control device of the multi-car elevator system in the second embodiment.

As illustrated in FIG. 9, when the cause is not contact with a human body, the torque limiting part 21c judges that loss due to panel deformation and alien object entry increases. On this occasion, the torque limiting part 21c raises the torque limit value in the position. As a result, the first car 2a or the like arrives at the full-open position at the time of door open even when loss due to alien object entry increases.

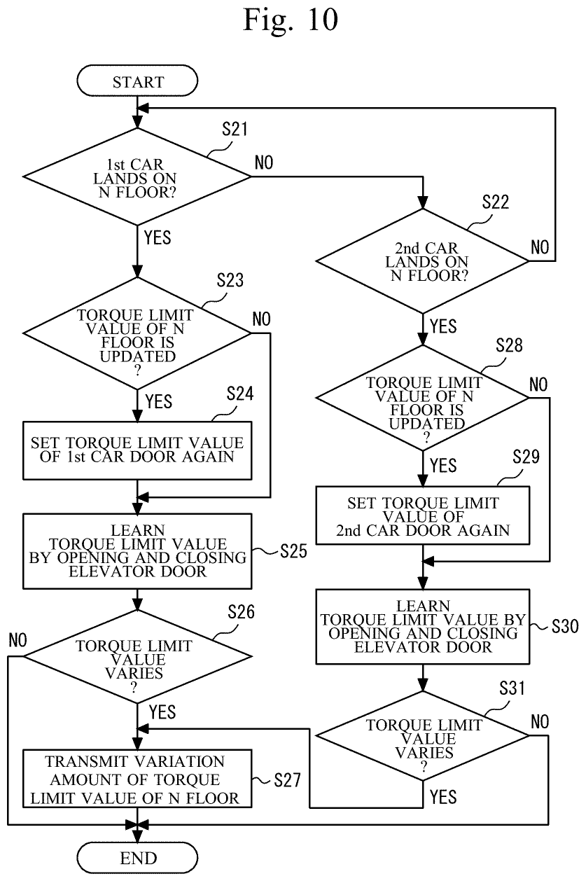

Next, with use of FIG. 10, operation of the multi-car elevator control device 6 will be described.

FIG. 10 is a flowchart for explaining the operation of the multi-car elevator control device of the multi-car elevator system in the second embodiment.

In step S21, the multi-car elevator control device 6 judges whether or not the first car 2a lands on the N floor.

When the first car 2a does not land on the N floor in step S21, the multi-car elevator control device 6 performs an operation in step S22.

In step S22, the multi-car elevator control device 6 judges whether or not the second car 2b lands on the N floor.

When the second car 2b does not land on the N floor in step S22, the multi-car elevator control device 6 performs the operation in step S21.

When the first car 2a lands on the N floor in step S21, the multi-car elevator control device 6 performs an operation in step S23.

In step S23, the multi-car elevator control device 6 judges whether or not the torque limit value of the N floor is updated.

When the torque limit value of the N floor is updated in step S23, the multi-car elevator control device 6 performs an operation in step S24. In step S24, the multi-car elevator control device 6 sets the torque limit value of the first car door 3a.

When the torque limit value of the N floor is not updated in step S23 or after step S24, the multi-car elevator control device 6 performs an operation in step S25. In step S25, the multi-car elevator control device 6 learns the torque limit value by opening and closing the door of the elevator.

Thereafter, the multi-car elevator control device 6 performs an operation in step S26. In step S26, the multi-car elevator control device 6 judges whether or not the torque limit value varies.

When the torque limit value varies in step S26, the multi-car elevator control device 6 performs an operation in step S27. In step S27, the multi-car elevator control device 6 transmits a distance variation amount of the N floor.

When the torque limit value does not vary in step S26 or after step S27, the multi-car elevator control device 6 ends the operation.

When the second car 2b lands on the N floor in step S22, the multi-car elevator control device 6 performs an operation in step S28.

In step S28, the multi-car elevator control device 6 judges whether or not the torque limit value of the N floor is updated.

When the torque limit value of the N floor is updated in step S28, the multi-car elevator control device 6 performs an operation in step S29. In step S29, the multi-car elevator control device 6 sets the torque set value of the second car door 3b.

When the torque limit value of the N floor is not updated in step S28 or after step S29, the multi-car elevator control device 6 performs an operation in step S30. In step S30, the multi-car elevator control device 6 learns the torque limit value by opening and closing the door of the elevator.

Thereafter, the multi-car elevator control device 6 performs an operation in step S31. In step S31, the multi-car elevator control device 6 judges whether or not the torque limit value varies.

When the torque limit value varies in step S31, the multi-car elevator control device 6 performs the operation in step S27.

When the torque limit value does not vary in step S31, the multi-car elevator control device 6 ends the operation.

According to the second embodiment described above, the change amount of the torque limit value of the second car 2b is reflected in the first car 2a. Accordingly, even when the loss increases due to panel deformation or alien object entry, wasted time of learning in the first car 2a can be reduced.

When the loss increases due to panel deformation or alien object entry, and the door is opened and closed by changing the torque limiting part 21c, the speed error between the speed instruction value and the actual speed is corrected by the speed control part 21b. On this occasion, due to increase in loss, a delay may occur in the actual speed with respect to the speed instruction value. In this case, when an external force occurs to the first car 2a or the like, the learned external force can be compensated in advance in the disturbance compensation part 21i. Specifically, in the turbulence compensation part 21i, the variation of the torque measured in the other car according to the position of the first door or the like from full close or full open, or the time after the open and close instruction is received can be reflected. In this case, the actual speed V with high followability to the speed instruction value V* is realized. Accordingly, the first car door 3a or the like can be opened and closed in a time determined by the speed instruction value. As a result, the motion of the first door or the like in a stable time can be provided to the user.

### Third Embodiment

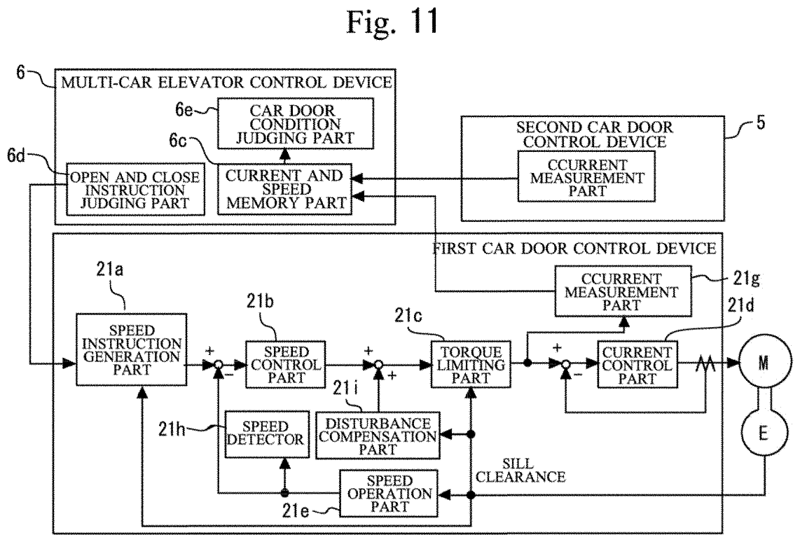

FIG. 11 is a block diagram for explaining a diagnosis function of a first car door control device of a multi-car elevator in a third embodiment. Same or corresponding parts as or to the parts of the first embodiment are assigned with the same reference signs. Explanation of the parts is omitted.

In a first car door control device 4 in FIG. 11, a current measurement part 21g stores a current instruction value of a motor 18 that is an output of a torque limiting part 21c in a first car 2a that opens and closes a door in a certain floor. A detected current value by a current detector may be stored instead of the current instruction value. The current measurement part 21g transmits information on the current instruction value of the motor 18 to a current memory part of a multi-car elevator control device 6 according to a door position from full close or full open, or a time after an open and close instruction is received.

A speed detector 21h stores an actual speed that is an output of a speed operation part 21e. The speed detector 21h transmits information on the actual speed according to a door position from full close or full open, or a time after the open and close instruction is received to a speed memory part of the multi-car elevator control device 6.

A second car door 3b control device also moves similarly to the first car door control device 4.

In the multi-car elevator control device 6, a car door condition judging part 6e judges abnormality of a first car door 3a or the like by memorizing currents and speeds of the first car 2a and a second car 2b that open and close on the same floor. For example, when a running loss of the first car door 3a that can be estimated from a current is larger than that of the second car 2b, the car door condition judging part 6e judges that the running loss of the first car door 3a tends to increase.

When a three or more cars exist, a car with the smallest running loss is used as a standard to judge the other cars. When running losses of many cars are similar to one another, a car with an extremely large or small running loss can be judged as abnormal.

According to the third embodiment described above, the multi-car elevator control device 6 judges an abnormal condition of the first car door 3a or the like based on the currents or speeds of the first car 2a and the second car 2b that open and close on the same floor. Accordingly, targets of work by maintenance staff can be limited. As a result, a maintenance work time during abnormality of the first car door 3a or the like can be shortened.

For example, if the currents and speeds of the first car 2a and the second car 2b that open and close on each floor immediately after installation of the elevator are memorized as data at an installation time, the first car door 3a or the like and the hatch door A in a specified floor can be diagnosed by a torque variation by comparison with data measured after installation about the first car 2a and the second car 2b.

Here, it is not possible to judge whether the car door or the hatch door has abnormality just because the torque variation from immediately after installation of the first car door 3a on the specific floor is large. If the torque variation from immediately after installation of the second car door 3b, measured on the same floor, is also large in this condition, it is possible to judge that the hatch door A has abnormality. In contrast with this, if the torque variation from immediately after installation of the second car door 3b measured on the same floor is not large, it is possible to judge that the first car 2a car door has abnormality.

Even if the data is not immediately after the installation of the elevator, if the data is older than the data measured this time, it is possible to judge that the first car door 3a or the like has abnormality by similar comparison.

On this occasion, if a current or speed trend is grasped by obtaining data regularly, it is also possible to grasp a tendency of occurrence of abnormality of the first car door 3a or the like. As a result, it is possible to improve accuracy of diagnosis of the first car door 3a or the like.

The same applies to the case of three or more cars.

### INDUSTRIAL APPLICABILITY

As above, the multi-car elevator control device of the present disclosure can be used for an elevator system.

### REFERENCE SIGNS LIST

1 hoistway, 2a first car, 2b second car, 3a first car door, 3b second car door, 4 first car door control device, 4a first car clearance distance measurement part, 4b first car torque limiting part, 4c first car current and speed detector, 5 second car door control device 5, 5a second car clearance distance measurement part, 5b second car torque limiting part, 5c second car current and speed detector, 6 multi-car elevator control device, 6a clearance distance memory part, 6b torque limit setting memory part, 6c current and speed memory part, 6d open and close instruction judging part, 6e car door condition judging part, 7 car door panel, 8 shoe, 9 hanger, 10 girder 11 guide rail 12 hanger roller 13 upthrust roller 14 pulley 15 belt, 16 belt holder, 17 car vane, 18 motor, 19 hatch door panel, 20 hall roller, 21a speed instruction generation part, 21b speed control part, 21c torque limiting part, 21d current control part, 21e speed operation part, 21f clearance distance measurement part, 21g current measurement part, 21h speed detector, 21i disturbance compensation part, 100a processor, 100b memory, 200 hardware

1. A multi-car elevator control device comprising, in an elevator system including a plurality of cars that overlap each other on a horizontal projection plane,
a processor to execute a program, and
a memory to store the program which, when executed by the processor, performs process of,
changing, based on a motor speed or current in a moving time of a car door of a specified car, a control parameter of a car door of another car.

2. The multi-car elevator control device according to claim 1,
wherein in the process of the changing,
using a clearance distance between a car door and a hatch door in each floor as the control parameter, based on the clearance distance estimated in one car door, a door open reacceleration position of another car door that lands on a same floor is changed.

3. The multi-car elevator control device according to claim 1, wherein, in the process of the changing, using a torque limit value in each floor as the control parameter, based on the torque limit value set in one car door, a torque limit value of another car door that lands on a same floor is changed.

4. The multi-car elevator control device according to claim 1, the program further performs process of judging a condition of the car door of the other car based on the motor speed or the current in the moving time of the car door of the specified car.

5. The multi-car elevator control device according to claim 4, wherein, in the process of the judging, using a motor speed or current in a moving time of a car door that is learned at an installation time of the elevator system as a standard, the condition of the door by comparing the motor speed or current that is measured this time with the standard is judged.

6. A multi-car elevator control device comprising, in an elevator system including a plurality of cars that overlap each other on a horizontal projection plane,
a processor to execute a program, and
a memory to store the program which, when executed by the processor, performs process of,
judging, based on a motor speed or current in a moving time of a car door of a specified car, a condition of a car door of another car.

7. The multi-car elevator control device according to claim 2, the program further performs process of judging a condition of the car door of the other car based on the motor speed or the current in the moving time of the car door of the specified car.

8. The multi-car elevator control device according to claim 7, wherein, in the process of the judging, using a motor speed or current in a moving time of a car door that is learned at an installation time of the elevator system as a standard, the condition of the door by comparing the motor speed or current that is measured this time with the standard is judged.

9. The multi-car elevator control device according to claim 3, the program further performs process of judging a condition of the car door of the other car based on the motor speed or the current in the moving time of the car door of the specified car.

10. The multi-car elevator control device according to claim 9, wherein, in the process of the judging, using a motor speed or current in a moving time of a car door that is learned at an installation time of the elevator system as a standard, the condition of the door by comparing the motor speed or current that is measured this time with the standard is judged.
